(19) United States
(12) Patent Application Publication
(10) Pub. No.: US 2022/0032321 A1
(43) Pub. Date: Feb. 3, 2022

(54) ELECTRIFICATION APPARATUS FOR ELECTRIC DUST COLLECTION

(71) Applicant: LG Electronics Inc., Seoul (KR)

(72) Inventors: Namgyu SHIN, Seoul (KR); Dong Hyuk LEE, Seoul (KR); Naehyun PARK, Seoul (KR); Ah Ram KIM, Seoul (KR); Giseop LEE, Seoul (KR)

(21) Appl. No.: 17/313,520

(22) Filed: May 6, 2021

(30) Foreign Application Priority Data
Jul. 30, 2020 (KR) 10-2020-0095188
Oct. 12, 2020 (KR) 10-2020-0131338
Feb. 1, 2021 (KR) 10-2021-0014207

(51) Int. Cl. B03C 3/47; B03C 3/41

(52) U.S. Cl. CPC B03C 3/47; B60H 3/0078; B03C 3/41

(57) ABSTRACT

An electrification apparatus for dust collection includes an electrification module configured to generate an ion that is emitted to air. The electrification module includes: at least one discharge tip configured to emit the ion in a direction opposite to a flow direction of the air, a conductive plate configured to generate a potential difference with the discharge tip, a frame that defines an appearance of the electrification module and that supports the discharge tip and the conductive plate, and a high voltage supplier configured to generate a voltage to supply the voltage to the discharge tip.

### CROSS-REFERENCE TO RELATED APPLICATION

This application claims priority to and the benefit of Korean Patent Application No. 10-2020-0095188, filed on Jul. 30, 2020, No. 10-2020-0131338, filed on Oct. 12, 2020, and No. 10-2021-0014207, filed on Feb. 1, 2021, the disclosure of which is incorporated herein by reference in its entirety.

### BACKGROUND

### Technical Field

The present disclosure relates to an electrification apparatus for electric dust collection, and one particular implementation relates to an electrification apparatus for electric dust collection including a high voltage supplier configured to generate a voltage to supply the voltage to a discharge tip disposed in a cover module, thereby maximizing space utilization and space efficiency.

### Description of Related Art

A method of removing particles may include two processes of electrification and dust collection. The method may electrify the dust and collect the electrified dust in a dust collecting filter.

Examples of dust collection may include physical dust collection using a nonwoven fabric, electric dust collection using a dielectric filter, and a method of applying an electrostatic force to a physical dust collecting filter using an electrostatic nonwoven fabric.

Electrification may include diffusion electrification, electric field electrification, and hybrid electrification (having both of diffuse electrification and electric field electrification).

The electric field electrification applied to the hybrid electrification is advantageous for collecting large particles and the diffusion electrification is advantageous for collecting small particles.

Korean Patent Publication No. 10-2020-0009889 discloses a structure to fix and support a conductive microfiber and a cable on an installation frame disposed at an inside of a main frame.

An electrification apparatus and a dust collecting apparatus are disposed in a dust collecting installation portion in a state in which the electrification apparatus is simply disposed on the dust collecting apparatus such as an air filter for vehicle and does not consider a high voltage supplier configured to supply a high voltage to the electrification apparatus and a configuration in which the high voltage supplier is disposed.

The electrification apparatus according to the related art document is connected, by a cable, to the high voltage supplier spatially spaced apart from the electrification apparatus to receive a power.

In this case, an additional space to accommodate the high voltage supplier may be obtained and an additional means for installing the high voltage supplier may be provided. An air conditioner for vehicle having severe space constraints may limit the provision of the space to accommodate the high voltage supplier.

In addition, an additional means for supporting and maintain the cable may be provided to receive the power, through the cable, from the high voltage supplier provided at the position spatially spaced apart from the electrification apparatus, that is, at a long distance. Therefore, the electrification apparatus may have a complicated structure.

### RELATED ART DOCUMENT

### Patent Document

(Patent Document 001) Korean Patent Publication No. 10-2020-0009889

### SUMMARY OF THE DISCLOSURE

The present disclosure is conceived to resolve the above-mentioned problems and provides an electrification apparatus for electric dust collection in which a high voltage supplier is disposed in a cover module coupled to an electrification module without obtaining an additional installation space for the high voltage supplier, thereby maximizing space utilization and space efficiency.

The present disclosure further provides an electrification apparatus for electric dust collection to supply a voltage to an individual discharge tip from the high voltage supplier using a single high voltage cable, thereby simplifying a wire structure and significantly reducing manufacturing costs thereof.

Aspects of the present disclosure are not limited to what has been described. Additionally, other aspects which are not mentioned may be understood by the following description and more clearly understood based on the embodiments of the present disclosure. Further, it will be readily understood that the aspects of the present disclosure may be implemented by features defined in claims and a combination thereof.

According to the present disclosure, an electrification apparatus for electric dust collection includes an electrification module to generate an ion emitted to flowing air, and the electrification module includes at least one discharge tip, a conductive plate, a frame, and a high voltage supplier. The electrification apparatus for electric dust collection may not need to obtain an additional installation frame for the high voltage supplier, thereby maximizing space utilization and space efficiency.

In addition, the electrification apparatus for electric dust collection may further include a cover module disposed at a front side of the electrification module and coupled to the frame and the high voltage supplier may be accommodated in the cover module.

In addition, the cover module may include an accommodator defining an accommodating space configured to accommodate the high voltage supplier and defining an opening at a rear surface thereof facing the frame.

In addition, a front surface of the accommodator protrudes in a direction away from the frame and the high voltage supplier is disposed between the front surface of the accommodator and the frame.

In addition, the cover module includes at least one terminal having a first end that protrudes from a front surface of the accommodator and a second end that protrudes to the accommodation space through the rear surface of the accommodator.

In addition, the cover module further includes a connector disposed on the front surface of the accommodator and the first end of the at least one terminal extends to an inside of the connector.

In addition, the cover module may be formed by insert-injecting the at least one terminal.

In addition, the connector may be integrated with the cover module.

In addition, the high voltage supplier may include a conductive first case disposed in the accommodator and defining an opening at a rear surface thereof, an insulating second case inserted into the first case through the open rear surface of the first case and defining an opening at a rear surface thereof, and a PCB substrate configured to place a plurality of circuit components and inserted into the open rear surface of the second case, and the PCB substrate is electrically connected to a second end of the at least one terminal.

In addition, the first case may include a first through-hole through which the second end of the at least one terminal passes and the second case may include a second through-hole through which the second end of the at least one terminal passes.

In addition, the high voltage supplier may further include a case grounding cable having a first end electrically connected to the PCB substrate and a second end electrically connected to the first case.

In addition, the second case may include a cable rib configured to fix the cable grounding cable.

In addition, the high voltage supplier may further include an insulating plate disposed at the open rear surface of the second case and a shielding plate disposed at a rear side of the insulating plate.

In addition, the electrification module may further include a high voltage cable configured to electrically connect the discharge tip to the PCB substrate.

In addition, the high voltage cable may include a single main cable having one end electrically connected to the PCB substrate.

The insulating plate may include a first cutting portion to pass one end of the main cable and the conductive plate may include a second cutting portion provided at a position corresponding to that of the first cutting portion and configured to pass one end of the main cable.

In addition, the electrification module may further include a grounding cable having a first end electrically connected to the PCB substrate and a second end electrically connected to the conductive plate, and the first end of the grounding cable may be connected to the PCB substrate through the first cutting portion and the second cutting portion.

According to the present disclosure, the electrification apparatus for electric dust collection includes the high voltage supplier disposed in the cover module coupled to the electrification module, thereby maximizing the space efficiency.

In addition, according to the present disclosure, the electrification apparatus for electric dust collection may connect only a single high voltage cable to the high voltage supplier, thereby simplifying a wire structure and significantly reducing manufacturing costs thereof.

In addition, according to the present disclosure, the electrification apparatus for electric dust collection includes a connector disposed at a front surface of the cover module and connected to an external power supply, thereby improving cleaning convenience or maintenance convenience of the electrification apparatus.

Hereafter, further effects of the present disclosure, in addition to the above-mentioned effects, are described together while describing specific matters for implementing the present disclosure.

### BRIEF DESCRIPTION OF THE DRAWINGS

FIG. 1 is a perspective view showing an example of an air conditioner for vehicle and an electrification apparatus for electric dust collection.

FIG. 2 is a rear perspective view showing the electrification apparatus for electric dust collection in FIG. 1.

FIG. 3 is an exploded perspective view showing the electrification apparatus for electric dust collection in FIG. 2.

FIG. 4 is an exploded perspective view showing an electrification module in FIG. 3.

FIG. 5 is a front perspective view and a cross-sectional view showing the electrification module in FIG. 3.

FIGS. 6A and 6B are partially enlarged views showing an upper frame in FIG. 5.

FIGS. 7A and 7B are partially enlarged views showing a lower frame in FIG. 5.

FIG. 8 is a perspective view showing a discharge tip and a tip holder in FIG. 3.

FIG. 9 is a cross-sectional view showing the discharge tip and the tip holder in FIG. 8.

FIGS. 10 and 11 are exploded perspective views showing the discharge tip and the tip holder in FIG. 8

FIG. 12 shows an example process of manufacturing a discharge tip and a tip holder.

FIG. 13 shows an example cable holder.

FIGS. 14 and 15 are rear perspective views showing an example of a cover module and a high voltage supplier.

FIGS. 16 and 17 are exploded perspective views showing the cover module and the high voltage supplier in FIG. 15.

FIGS. 18 to 21 are perspective views showing an example high voltage supplier disposed in a cover module.

### DETAILED DESCRIPTION OF EXEMPLARY IMPLEMENTATIONS

Some embodiments of the present disclosure are described in detail with reference to accompanying drawings, such that a person having ordinary knowledge in the art to which the present disclosure pertains may easily implement the technical idea of the present disclosure. A detailed description of a well-known technology relating to the present disclosure may be omitted if it unnecessarily obscures the gist of the present disclosure. One or more embodiments of the present disclosure are described in detail with reference to the accompanying drawings. Same reference numerals may be used to refer to same or similar components.

It will be understood that, the terms “first”, “second”, and the like may be used herein to describe various components; however, these components should not be limited by these terms. These terms are only used to distinguish one component from another component. Thus, a first component may be a second component unless otherwise stated.

Unless otherwise stated, each component may be singular or plural through the disclosure.

In this document, the terms “upper,” “lower,” “on,” “under,” or the like are used such that, where a first component is arranged at “an upper portion” or “a lower portion” of a second component, the first component may be arranged in contact with the upper surface or the lower surface of the second component, or another component may be disposed between the first component and the second component. Similarly, where a first component is arranged on or under a second component, the first component may be arranged directly on or under (in contact with) the second component, or at least one other components may be disposed between the first component and the second component.

Further, the terms “connected,” “coupled,” or the like are used such that, where a first component is connected or coupled to a second component, the first component may be directly connected or able to be connected to the second component, or at least one additional components may be disposed between the first and second components, or the first and second components may be connected or coupled through at least one additional components.

In some examples, singular expressions used in the present disclosure include plural expressions unless the context clearly indicates otherwise. In the present disclosure, terms such as “including” or “comprising” should not be construed as necessarily including all of the various components, or various steps described in the present disclosure, and terms such as “including” or “comprising” should be construed as not including some elements or some steps or further including additional elements or steps.

In the present disclosure, unless otherwise stated, “A and/or B” means A, B, or both. Unless otherwise stated, “C to D” means “C or more and D or less”.

Hereinafter, the present disclosure is described with reference to the drawings for explaining an electrification apparatus for electric dust collection 100 according to embodiments of the present disclosure.

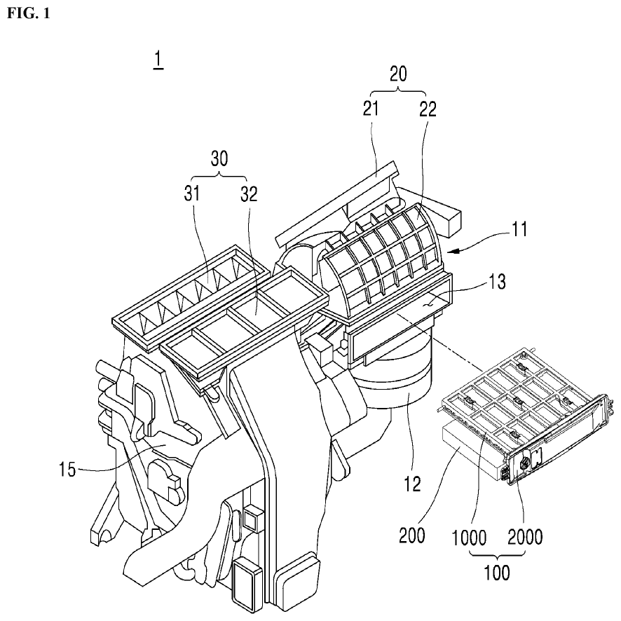

With reference to FIGS. 1 to 3, an assembly structure of the electrification apparatus for electric dust collection 100 and an air conditioner for vehicle 1 according to an embodiment of the present disclosure is described schematically and the assembly structure is described schematically.

<Overall Configuration>

FIG. 1 is a perspective view showing an example of an electrification apparatus for electric dust collection 100 and an air conditioner for vehicle 1 in which the electrification apparatus for electric dust collection 100 is disposed.

As shown in FIG. 1, the electrification apparatus for electric dust collection 100 according to an embodiment of the present disclosure may be disposed in the air conditioner for vehicle 1.

However, the present disclosure is not limited thereto, and may be applied to various types of air conditioners, for example, building air conditioners, household air conditioners, and air purifiers. Hereinafter, the electrification apparatus for electric dust collection 100 disposed in the air conditioner for vehicle 1 is described as an example.

The air conditioner for vehicle 1 may include main bodies 11 and 15 defining an outer appearance. The main body may include a suction main body 11 defining a suction inlet 20 and a discharge main body 15 defining a discharge outlet 30.

The suction main body 11 and the discharge main body 15 communicate with each other to flow air.

A plurality of suction inlets 20 may be defined in the suction main body 11 and a plurality of discharge outlets 30 may be defined in the discharge main body 15.

The suction inlet 20 may include an indoor suction inlet 21 and an outdoor suction inlet 22. The indoor suction inlet 21 may be an inlet through which internal air of a vehicle in which the air conditioner for vehicle 1 is installed is introduced into the main body 11. In addition, the outdoor suction inlet 22 may be an inlet through which external air of the vehicle is introduced into the main body 11.

The discharge outlet 30 may include a front discharge outlet 31 and a defrost discharge outlet 32. The front discharge outlet 31 may be an outlet through which air discharged from the main body 11 flows into the vehicle. In addition, the defrost discharge outlet 32 may be an outlet through which the air discharged from the main body 11 flows to the window of the vehicle.

In addition, the air conditioner for vehicle 1 may include a fan and a heat exchanger disposed in the main bodies 11 and 15.

In addition, the air conditioner for vehicle 1 may further include a damper to selectively open the plurality of suction inlets 20 and discharge outlets 30. For example, the damper may open a first one among the indoor suction inlet 21 and the outdoor suction inlet 22 and close a second one thereof. In addition, the damper may open at least one of the plurality of discharge outlets 30.

In addition, an electrification apparatus for electric dust collection 100 and a dust collecting apparatus 200 may each be disposed in the air conditioner for vehicle 1.

The electrification apparatus for electric dust collection 100 electrifies foreign substances such as dust particles in the air. In addition, the dust collecting apparatus 200 collects the dust particles or the like electrified by the electrification apparatus for electric dust collection 100 and remove the dust particles from the air.

The electrification apparatus for electric dust collection 100 may include an electrification module 1000 having a discharge tip 1100 and a conductive plate 1200 described below.

A high voltage is applied to the discharge tip 1100 and a ground voltage is applied to the conductive plate 1200. Accordingly, the electrification apparatus for electric dust collection 100 may generate ions in the air to form an electric field.

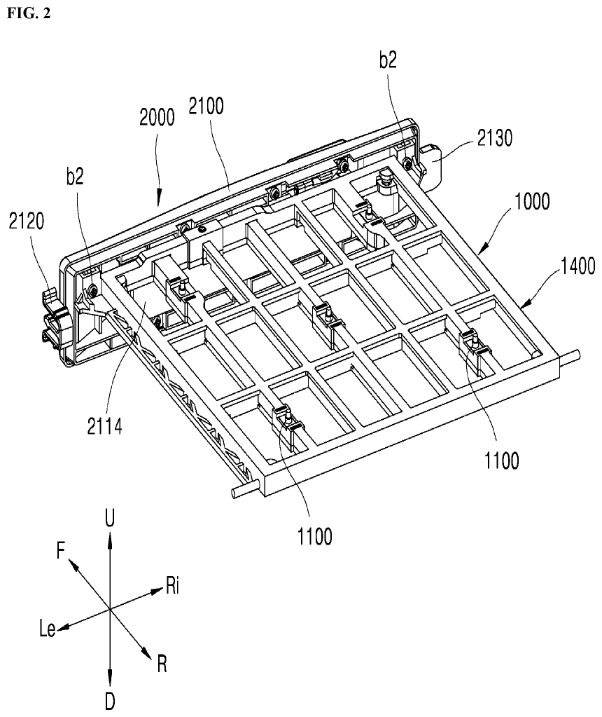

In this case, the conductive plate 1200 may generate an electric field by generating a potential difference with the discharge tip 1100. A detailed configuration of the electrification apparatus for electric dust collection 100 is described below with reference to FIG. 2.

The dust collecting apparatus 200 corresponds to a type of filter to collect particles electrified by the electrification apparatus for electric dust collection 100 and may be made of various materials.

For example, the dust collecting apparatus 200 may be configured as a porous filter made of a fiber such as a nonwoven fabric. In addition, a conductive material may be applied, coated, or attached to a surface of the dust collecting apparatus 200.

With this configuration, the dust particles or the like in the air passing through the electrification apparatus for electric dust collection 100 are combined with ions generated by the electrification apparatus for electric dust collection 100 and are electrified. In addition, the electrified dust particles may be collected by the electrification apparatus for electric dust collection 100 or the dust collecting apparatus 200.

The electrification apparatus for electric dust collection 100 according to an embodiment of the present disclosure may be provided as a separate device from the dust collecting apparatus 200.

The electrification apparatus for electric dust collection 100 and the dust collecting apparatus 200 may be produced and distributed by different manufacturing processes and distribution processes. In addition, the electrification apparatus for electric dust collection 100 and the dust collecting apparatus 200 may be coupled to each other by an additional coupling member and may be provided on the air conditioner for vehicle 1.

As shown in FIG. 1, the air conditioner for vehicle 1 includes a dust collecting installation portion 13 in which the electrification apparatus for electric dust collection 100 and the dust collecting apparatus 200 are disposed. For example, the dust collecting installation portion 13 is disposed in the suction main body 11 adjacent to the suction inlet 20.

In particular, the dust collecting installation portion 13 is disposed at a lower side in a flow direction of the air flowing into the suction inlet 20 to pass the air introduced into the suction inlet 20 through the electrification apparatus for electric dust collection 100 before the dust collecting apparatus 200.

In addition, the air conditioner for vehicle 1 includes a fan installation portion 12 in which a fan is installed. The fan installation portion 12 is disposed at the suction main body 11 adjacent to the suction inlet 20. In particular, the fan installation portion 12 is disposed under the dust collecting installation portion 13 in the air flow direction.

That is, the suction inlet 20, the dust collecting installation portion 13, and the fan installation portion 12 are sequentially disposed at the suction main body 11 in the air flow direction. In this structure, the air may be introduced into the suction inlet 20 and may sequentially pass through the electrification apparatus for electric dust collection 100, the dust collecting apparatus 200, and the fan, and may flow to the discharge main body 15.

The electrification apparatus for electric dust collection 100 and the dust collecting apparatus 200 may each be disposed in the dust collecting installation portion 13. In particular, the dust collecting apparatus 200 is disposed below the electrification apparatus for electric dust collection 100 in the air flow direction. In this structure, the air introduced into the suction inlet 20 may sequentially pass through the electrification apparatus for electric dust collection 100 and the dust collecting apparatus 200 and may flow.

The electrification apparatus for electric dust collection 100 may be disposed on the dust collecting apparatus 200. In that state, the electrification apparatus for electric dust collection 100 may be disposed in the dust collecting installation portion 13. That is, as shown, the electrification apparatus for electric dust collection 100 and the dust collecting apparatus 200 may overlap with each other and may be seated on the dust collecting installation portion 13.

As the electrification apparatus for electric dust collection 100 and the dust collecting apparatus 200 are individually disposed, the electrification apparatus for electric dust collection 100 and the dust collecting apparatus 200 may be managed separately. For example, a user may replace and wash the dust collecting apparatus 200 by separating only the dust collecting apparatus 200 from the air conditioner for vehicle 1.

In particular, replacement cycles of the electrification apparatus for electric dust collection 100 and the dust collecting apparatus 200 may be different from each other. As a larger amount of dust particles and the like are collected in the dust collecting apparatus 200, the replacement cycle of the dust collecting apparatus 200 may be shorter. Therefore, the user may replace only the dust collecting apparatus 200 without having to replace the electrification apparatus for electric dust collection 100, thereby improving user convenience.

<Configuration of Electrification Apparatus for Electric Dust Collection>

Hereinafter, an electrification apparatus for electric dust collection 100 according to an embodiment of the present disclosure is described.

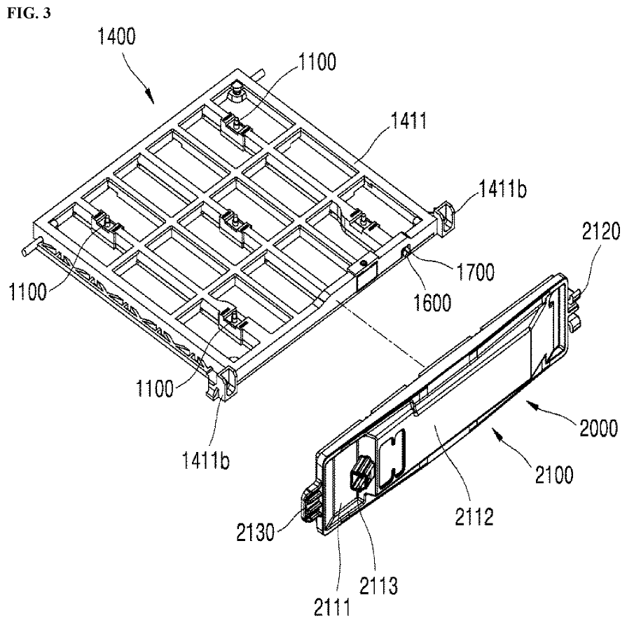

FIG. 2 is a rear perspective view showing an example electrification apparatus for electric dust collection 100. FIG. 3 is an exploded perspective view showing an electrification module 1000 and a cover module 2000 separated from the electrification apparatus for electric dust collection 100 in FIG. 2.

Referring to FIGS. 2 and 3, the electrification apparatus for electric dust collection 100 according to an embodiment of the present disclosure may include an electrification module 1000 to electrify foreign substances such as dust particles contained in the passing air and a cover module 2000 disposed at a front side of the electrification module 1000.

The electrification module 1000 is entirely inserted into the dust collecting installation portion 13 and is directly exposed to the flowing air.

The cover module 2000 is coupled to an opening of the dust collecting installation portion 13 into which the electrification module 1000 is inserted and blocks the opening thereof. That is, the cover module 2000 functions as a cap.

The cover module 2000 includes a cover 2100, which functions as the cap.

A high voltage supplier 2200 may be accommodated in the cover 2100 to generate a high voltage to supply the high voltage to the electrification module 1000. That is, according to the present disclosure, for the electrification apparatus for electric dust collection 100, the high voltage supplier 2200 is accommodated in the cover 2100 adjacent to the electrification module 1000. In this case, an additional installation space for the high voltage supplier 2200 may not need to be provided, thereby remarkably improving space efficiency compared to the related art.

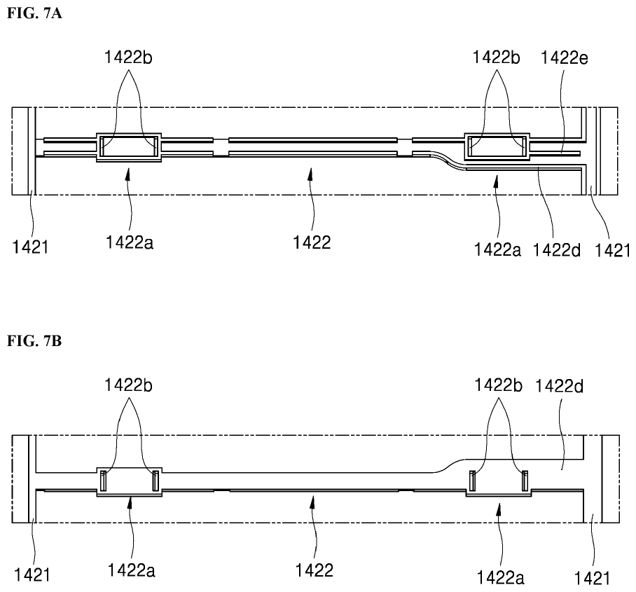

A high voltage cable 1600 to supply a voltage to the discharge tip 1100 and a grounding cable 1700 to ground a conductive plate 1200 may each be electrically connected to the high voltage supplier 2200. A connection configuration of the high voltage supplier 2200 and the grounding cable 1700 is described below with reference to FIG. 7.

As shown in FIG. 3, a protruding surface 2112 is defined on a front surface 2111 of the cover 2100 and at least partially protrudes forward. In this structure, an accommodator including an accommodating space configured to accommodate the high voltage supplier 2200 may be disposed at a rear side of the protruding surface 2112.

As shown in FIG. 3, a main connector 2113 to supply external power to the high voltage supplier 2200 may be integrated with the front surface 2111 of the cover 2100 or may be provided separately from the front surface 2111 of the cover 2100.

A hook-shaped retainer 2120 and a locking protrusion 2130 may be defined at both sides of the cover module 2000 for detachable coupling to the dust collecting installation portion 13.

As shown in FIG. 3, the electrification module 1000 and the cover module 2000 may be detachably coupled to each other by a second bolt b2. For example, a connector 1411b of the electrification module 1000 may be coupled to the rear surface of the cover 2100 using the second bolt (b2).

<Detailed Configuration of Electrification Module>

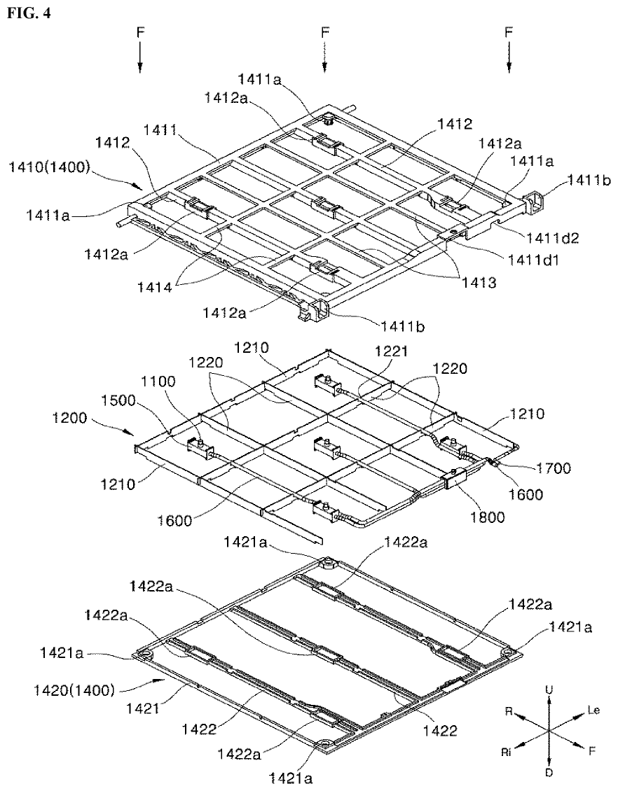

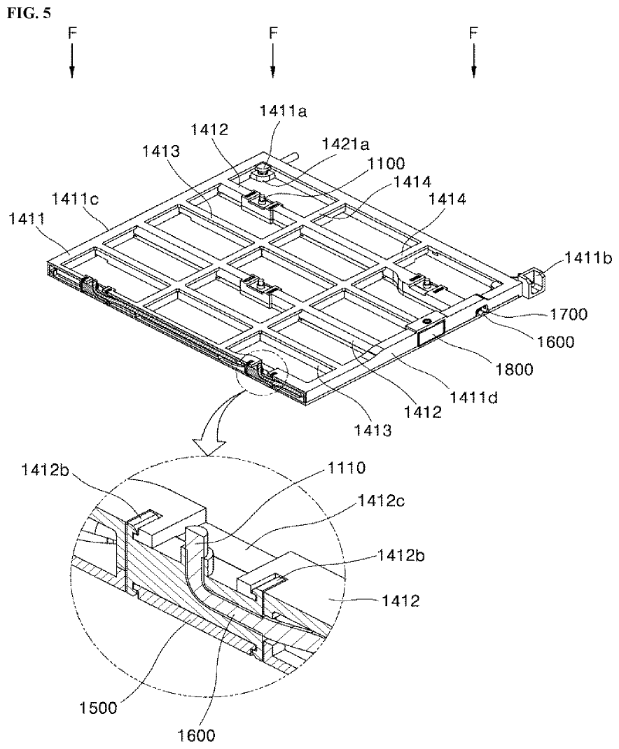

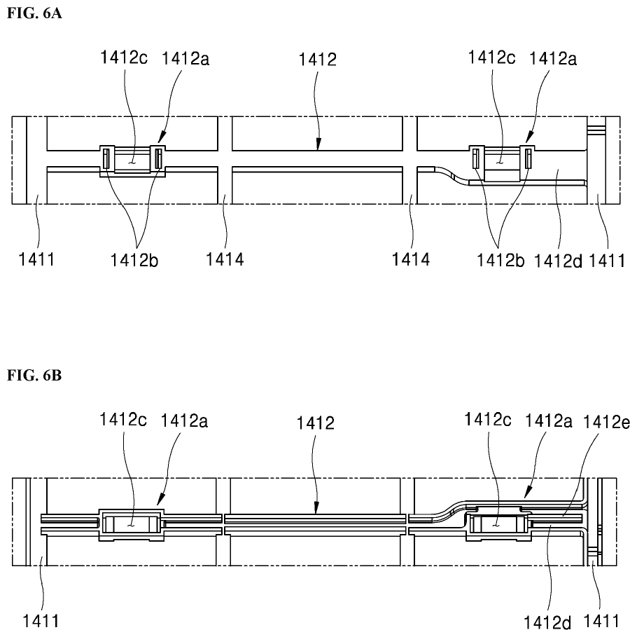

FIG. 4 is an exploded perspective view showing an electrification module 1000. FIG. 5 is a cross-sectional view showing an electrification module 1000. FIGS. 6A, 6B, 7A, and 7B are partially enlarged views of a frame 1400.

Hereinafter, an electrification module 1000 of an electrification apparatus for electric dust collection 100 according to an embodiment of the present disclosure is described with reference to FIGS. 4 to 7B.

The electrification module 1000 may include a frame 1400 defining an outer appearance, a discharge tip 1100 disposed on the frame 1400, and a conductive plate 1200.

The conductive plate 1200 forms an electric field together with the discharge tip 1100. In addition, the conductive plate 1200 may be provided as a metal plate having a predetermined thickness, and a ground cable 1700 for grounding may be connected to the conductive plate 1200. In this case, a potential difference is generated between the conductive plate 1200 and the discharge tip 1100 to generate an electric field.

In addition, high-density ions may be generated between the discharge tip 1100 and the conductive plate 1200.

As the conductive plate 1200 is provided as a flat plate having the predetermined width along a vertical direction (i.e., a U-D direction), predetermined dust particles or the like may be collected on the conductive plate 1200. At least a portion of the conductive plate 1200 is covered by an upper frame 1400 described below to prevent direct adhesion of the dust particles to the conductive plate 1200.

The conductive plate 1200 surrounds the discharge tip 1100. For example, the conductive plate 1200 forms a predetermined electrification space surrounding the discharge tip 1100. In this case, the electrification space may be closed by the conductive plate 1200 in a front-rear direction (i.e., an F-R direction) and a lateral direction (i.e., an Le-Ri direction), and may be open in a vertical direction (i.e., a U-D direction).

In particular, the conductive plate 1200 defines a rectangular column-shaped electrification space. Advantageously, the electrification space may have a square column-shape to equalize a magnetic field and ion emission.

In this case, the discharge tip 1100 may be disposed at a center of the electrification space and may emit ions in a direction opposite to a flow direction (F) of the air.

The electrification space refers to a space to surround a discharge tip 1100. Accordingly, a number of electrification spaces may correspond to a number of discharge tips 1100.

In this embodiment, a total of nine electrification spaces are formed as an example. In this case, the discharge tips 1100 may be disposed in individual electrification spaces or may be disposed only in some electrification spaces.

The illustrated embodiment discloses a total of five discharge tips 1100, and the number of discharge tips 1100 may be adjusted based on a needed amount of ion emission or a flow rate of air. Hereinafter, as illustrated, a total of five discharge tips 1100 are disposed.

The conductive plate 1200 may include an outer plate 1210 defining a plurality of electrification spaces and an inner plate 1220 configured to partition the plurality of electrification spaces.

The outer plate 1210 forms an outer circumference of the conductive plate 1200. For example, the outer plate 1210 may have a rectangular frame shape.

In the present embodiment, a total of three outer plates 210 may form a U-shaped rectangular frame defining an opening at a front side thereof. As shown in FIG. 4, the outer plate 1210 may not be provided at a position adjacent to the cover module 2000 to avoid interference with the high voltage cable 1600 configured to supply voltage to the discharge tip 1100 and may be opened.

The inner plate 1220 divides the space formed by the outer plate 1210 into individual electrification spaces.

As shown, the inner plate 1220 extends in the front-rear direction (i.e., the F-R direction) or the lateral direction (i.e., the Le-Ri direction). For example, the inner plates 1220 may cross each other to divide the space formed by the outer plate 1210 into nine electrification spaces.

In this case, the outer plate 1210 and the inner plate 1220 may be integrated with each other, or may be separately manufactured and coupled to each other.

As shown in FIG. 4, the inner plate 1220 may include a notch 1221 through which a high voltage cable 1600 to supply a voltage to an individual discharge tip 1100 passes.

The frame 1400 defines an appearance of the electrification module 1000 and supports and fixes the discharge tip 1100 and the conductive plate 1200 at a predetermined position.

The frame 1400 may be made of a non-conductive material, for example, plastic. In addition, the frame 1400 may be formed in various shapes by an injection process.

The frame 1400 may include an upper frame 1410 disposed on the discharge tip 1100 and the conductive plate 1200 and a lower frame 1420 disposed under the discharge tip 1100 and the conductive plate 1200.

The upper frame 1410 and the lower frame 1420 may be detachably coupled to each other. For the detachable coupling, the upper frame 1410 may include a plurality of coupling hooks 1411a that protrude and extend toward the lower frame 1420. For example, the individual coupling hooks 1411a may be disposed along a circumferential direction thereof and may be disposed at four corner sides of an upper outer frame 1411 described below.

The lower frame 1420 may include a ring-shaped coupling ring 1421a into which the coupling hook 1411a is inserted and with which the coupling hook 1411a is engaged. As the coupling hook 1411a is inserted into an insertion hole of the coupling ring 1421a, the coupling hook 1411a may be engaged with the coupling ring.

However, this is merely an example, and other fastening means or coupling means may be provided.

As the upper frame 1410 and the lower frame 1420 are coupled to each other, the outer plate 1210 of the conductive plate 1200 and the discharge tip 1100 may be disposed and supported between the upper frame 1410 and the lower frame 1420.

A detailed configuration of the frame 1400 is described below with reference to FIGS. 5 to 7B.

The discharge tip 1100 ionizes molecules in the air by high-voltage discharge. For example, the discharge tip 1100 may generate an anion such as OH— and O— or a cation such as H+ in the air.

A high voltage cable 1600 may be connected to the discharge tip 1100 to supply a high voltage.

In addition, the discharge tip 1100 may include a discharge brush 1110 to directly generate discharge. For example, the discharge brush 1110 may be made of a plurality of carbon fibers. The carbon fiber may include microfibers having a diameter of a micrometer unit, and when a high voltage is applied to the carbon fiber through the high voltage cable 1600, ions may be generated in the air by corona discharge.

The discharge tip 1100 is disposed on the frame 1400 and extends in the vertical direction (i.e., the U-D direction), and preferably protrudes in a direction opposite to a flow direction (F) of air. Therefore, a diffusion effect of the emitted ions may be maximized and the dust particles contained in the air may be evenly electrified.

The discharge tip 1100 may be firmly supported by the tip holder 1500 and may be firmly coupled to the frame 1400 using the tip holder 1500.

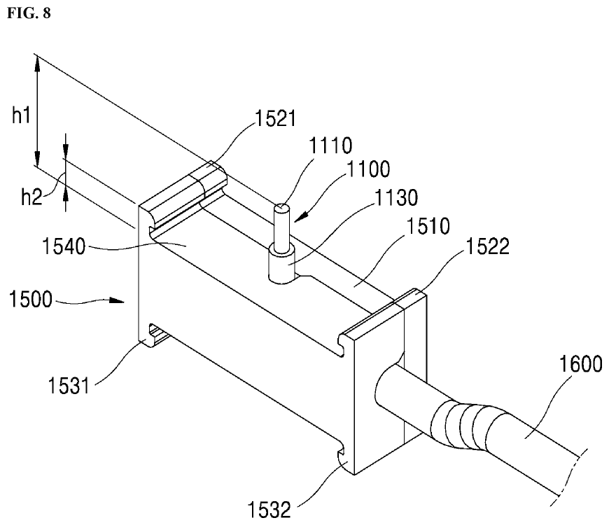

Detailed configurations of the discharge tip 1100 and the tip holder 1500 are described below with reference to FIG. 8.

<Detailed Configuration of Frame>

Hereinafter, a detailed configuration of a frame 1400 of an electrification module 1000 according to an embodiment of the present disclosure is described with reference to FIGS. 5 to 7B.

As shown in FIGS. 5, 6A, and 6B, the frame 1400 includes an upper frame 1410 configured to support a conductive plate 1200 and a tip holder 1500 of a discharge tip 1100 from a top thereof or cover the conductive plate 1200 and the tip holder 1500 of the discharge tip 1100.

The upper frame 1410 includes an upper outer frame 1411, a first upper inner frame 1412, a second upper inner frame 1413, and a third upper inner frame 1414.

The upper outer frame 1411 corresponds to an outermost portion thereof and is a rectangular outer edge having a predetermined height.

The upper outer frame 1411 has a U-shaped cross-section and defines an opening at a lower surface thereof, and an outer plate 1210 disposed outside of the conductive plate 1200 is partially accommodated in the U-shaped inner space. That is, an upper surface of the outer plate 1210 is covered by the upper outer frame 1411.

A high voltage cable 1600 and a cable holder 1800 described below are each accommodated in an inner space of a front end 1411d of the upper outer frame 1411 corresponding to a portion of the conductive plate 1200 in which the outer plate 1210 is not disposed.

A first notch 1411d1 having an outer shape corresponding to that of the cable holder 1800 may be defined in the portion where the cable holder 1800 is accommodated and a second notch 1411d2 may be defined to pass through the high voltage cable for connecting one end of the high voltage cable to the high voltage supplier 2200.

The first upper inner frame 1412 extends from an inside of the upper outer frame 1411 in the front-rear direction (i.e., the F-R direction) and may be integrated with the upper outer frame 1411.

Similar to the upper outer frame 1411, the first upper inner frame 1412 defines an opening at a lower surface thereof, has a U-shaped cross section, and accommodates the high voltage cable 1600 configured to supply voltage to the discharge tip 1100 at an inside of the U-shaped structure.

In addition, the first upper inner frame 1412 includes a first coupling portion 1412a to which an upper surface of the tip holder 1500 described below is coupled.

As shown in FIGS. 5 and 6A, the first coupling portion 1412a has an inner shape corresponding to an outer shape of an upper portion of the tip holder 1500. A first coupling hole 1412b is defined on an upper surface of the first coupling portion 1412a and upper hooks 1521 and 1522 of the tip holder 1500 described below pass through the first coupling hole 1412b.

In addition, the upper surface of the first coupling portion 1412a except for the first coupling holes 1412b is mostly open and the discharge tip 100 coupled to the tip holder 1500 is exposed to outside through an opening hole 1412c.

As shown in the enlarged view of FIG. 5, the open hole 1412c may extend to both sides of the first upper inner frame 1412. That is, the open hole 1412c may be formed by cutting the upper surface of the first coupling portion 1412a to a predetermined depth, thereby minimizing interference between the discharge tip 1100 and the first coupling portion 1412a and maximizing the discharge efficiency of the discharge tip 1100.

The first upper inner frame 1412 disposed immediately adjacent to the upper outer frame 1411 may include two first couplings 1412a to which two tip holders 1500 may be coupled.

In this case, as shown in FIGS. 6A and 6B, a first extension portion 1412d may be disposed at the first coupling portion 1412a, which is provided adjacent to the front end 1411d of the upper outer frame 1411, to pass through the high voltage cable 1600 configured to supply power to the discharge tip 1100 disposed adjacent to the rear end 1411c.

The high voltage cable 1600 avoids and bypasses the first coupling portion 1412a, which is disposed adjacent to the front end 1411d of the upper outer frame 1411 and moves toward the rear end 1411c to supply the power to the discharge tip 1100 disposed adjacent to the rear end 1411c of the upper outer frame 1411 through the first extension portion 1412d.

In this case, as shown in FIG. 6B, a first partition wall 1412e may be disposed between the first extension portion 1412d and the front end 1411d of the upper outer frame 1411 to separately accommodate two high voltage cables 1600. The first partition wall 1412e extends in a linear shape and divides an inner space that extends from the front end 1411d of the upper outer frame 1411 to the first coupling portion 1412a together with a second partition wall 1422e described below.

The second upper inner frame 1413 is disposed inside the upper outer frame 1411, and extends in the front-rear direction (i.e., F-R direction) in parallel to the first upper inner frame 1412.

The second upper inner frame 1413 covers an upper surface of the inner plate 1220 that extends in the front-rear direction (i.e., the F-R direction) to minimize a rate at which electrified dust particles are directly adhered to the inner plate 1220.

As shown, the first upper inner frame 1412 and the second upper inner frame 1413 are alternately arranged in parallel to each other.

The third upper inner frame 1414 extends inside the upper outer frame 1411 in a direction crossing each of the first upper inner frame 1412 and the second upper inner frame 1413.

Similar to the second upper inner frame 1413, the third upper inner frame 1414 covers the upper surface of the inner plate 1220 that extends in the lateral direction (i.e., the Le-Ri direction).

That is, the third upper inner frame 1414 and the second upper inner frame 1413 form a grid structure having an intersection point to at least partially cover and support the upper surface of the inner plate 1220 of the conductive plate 1200 having the same grid structure.

As shown in FIGS. 4 and 7B, the lower frame 1420 to support the conductive plate 1200 and the tip holder 1500 from under the conductive plate 1200 and the tip holder 1500 includes a lower outer frame 1421 and a lower inner frame 1422.

The lower outer frame 1421 corresponds to an outermost portion thereof, has a shape corresponding to that of the upper outer frame 1411 of the upper frame 1410, and is coupled to the opened lower surface of the upper outer frame 1411.

In this case, the outer plate 1210 of the conductive plate 1200 may be entirely accommodated by the upper outer frame 1411 and the lower outer frame 1421.

The lower inner frame 1422 is coupled to an opened lower surface of the first upper inner frame 1412 and extends in the front-rear direction (i.e., the F-R direction) similar to the first upper inner frame 1412.

The lower inner frame 1422 includes a second coupling portion 1422a corresponding to the first coupling portion 1412a. A lower surface of the tip holder 1500 described below is coupled to the second coupling portion 1422a.

The second coupling portion 1422a has an inner shape corresponding to an outer shape of the lower surface of the tip holder 1500, and a second coupling hole 1422b is defined at a lower surface of the second coupling portion 1422a and lower hooks 1531 and 1532 of the tip holder 1500 described below pass through the second coupling hole 1422b.

The lower inner frame 1422 disposed immediately adjacent to the lower outer frame 1421 may include two second coupling portions 1422a to be coupled to the two tip holders 1500.

A second extension portion 1422d is disposed at the second coupling portion 1422a, which is disposed adjacent to the front end of the lower outer frame 1421, to pass through a high voltage cable 1600 configured to supply power to the discharge tip 1100 disposed adjacent to the rear end of the lower outer frame 1421.

The high voltage cable 1600 avoids and bypasses the second coupling portion 1422a disposed adjacent to the front end of the lower outer frame 1421 and is moved toward the rear end thereof to supply the power to the discharge tip 1100 disposed adjacent to the rear end of the lower outer frame 1421 through the second extension portion 1422d.

In this case, as shown in FIG. 7A, a second partition wall 1422e may be disposed between the second extension portion 1422d and the front end of the lower outer frame 1421 to separately accommodate two high voltage cables 1600. The second partition wall 1422e extends linearly and divides an inner space that extends from the front end of the lower outer frame 1421 to the second coupling portion 1422a together with the first partition wall 1412e.

<Detailed Configuration of Discharge Tip and Tip Holder>

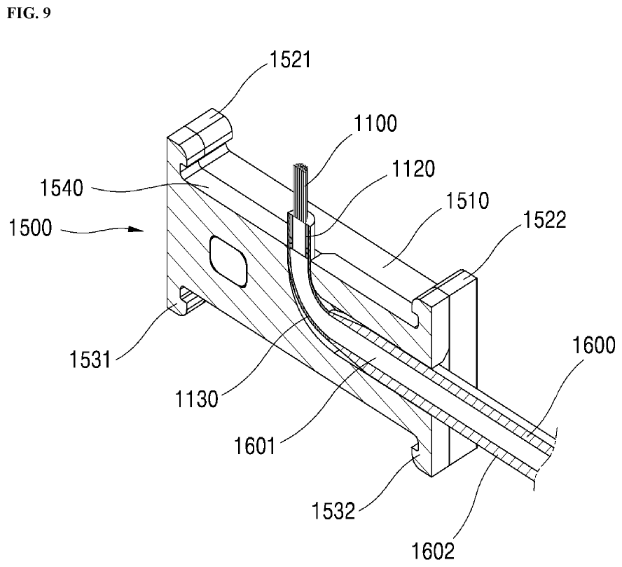

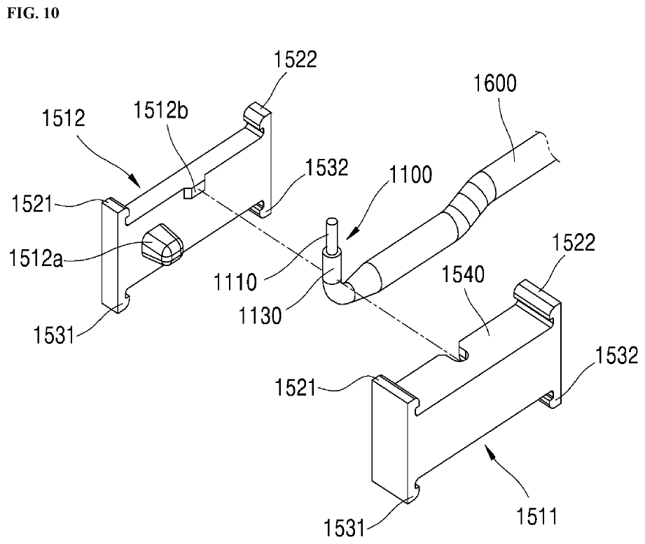

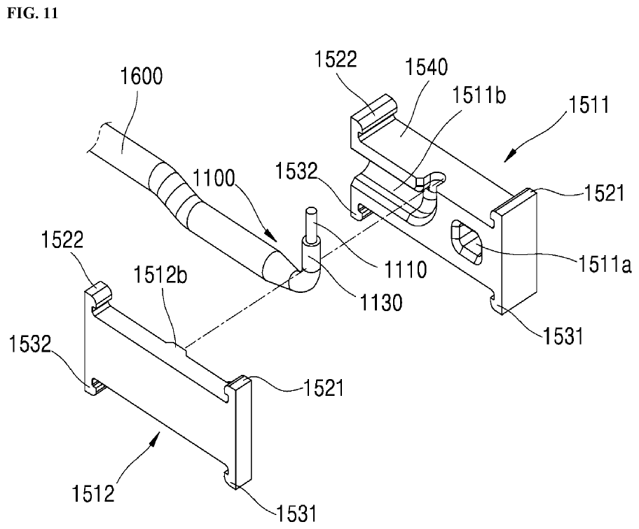

Hereinafter, detailed configurations of a discharge tip 1100 and a tip holder 1500 of an electrification module 1000 according to an embodiment of the present disclosure are described with reference to FIGS. 8 to 12.

The electrification module 1000 according to the present disclosure includes a plurality of discharge tips 1100 and a plurality of tip holders 1500. Description below applies almost the same to the individual discharge tip 1100 and the tip holder 1500 unless otherwise noted.

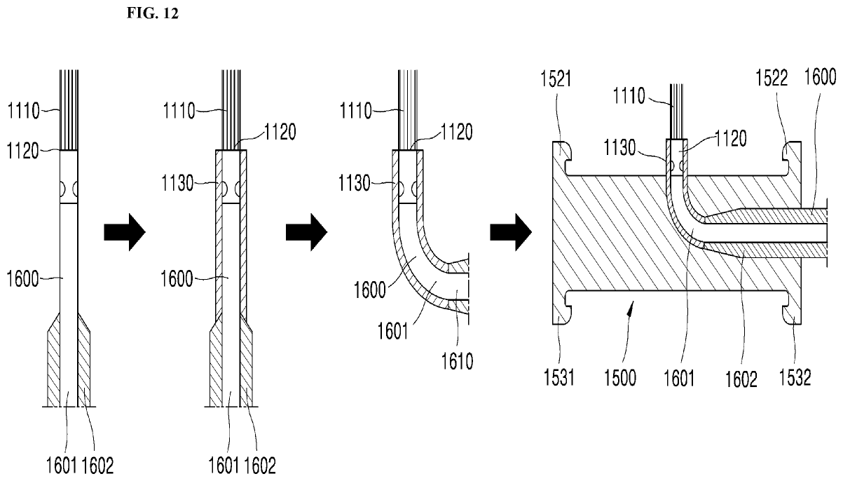

FIGS. 8 to 11 show a tip holder 1500 according to a first embodiment. FIG. 12 shows a tip holder 1500 according to a second embodiment.

The tip holder 1500 of the electrification apparatus for electric dust collection 100 according to an embodiment of the present disclosure may be manufactured separately from the discharge tip 1100 and a high voltage cable 1600 and coupled to the discharge tip 1100 and the high voltage cable 1600, or may be manufactured by insert injection in a state in which the discharge tip 1100 and the high voltage cable 1600 are disposed in a mold.

A configuration in which the tip holder 1500 is separately manufactured according to the first embodiment is described with reference to FIGS. 8 to 11.

The tip holder 1500 includes a hexahedral main body 1510 to support the discharge tip 1100 and the high voltage cable 1600, and the main body 1510 includes a first half body 1511 and a second half body 1512. The first half body 1511 and the second half body 1512 may be manufactured separately from the discharge tip 1100 and the high voltage cable 1600 by injection molding.

The discharge tip 1100 and the high voltage cable 1600 are pressed and supported by the first half body 1511 and the second half body 1512 in a state in which the discharge tip 1100 and the high voltage cable 1600 are at least partially disposed between the first half body 1511 and the second half body 1512.

The first half body 1511 includes a cable seating groove 1511b to accommodate the high voltage cable 1600 and the discharge tip 1100 and having a shape corresponding to outer shapes of a heat shrinkable tube 1130 to support the discharge tip 1100 and the high voltage cable 1600.

In addition, the first half body 1511 has a larger thickness than that of the second half body 1512 described below to accommodate the high voltage cable 1600 and the discharge tip 1100.

A coupling groove 1511a is defined in the first half body 1511 to couple to the second half body 1512 described below and a coupling protrusion 1512a of the second half body 1512 is inserted into the coupling groove 1511a.

The second half body 1512 is coupled to one surface of the first half body 1511 defining the cable seating groove 1511b to prevent the high voltage cable 1600 and the discharge tip 1100 from being separated and maintains a press state for the high voltage cable 1600 and the discharge tip 1100.

A pressing protrusion 1512b configured to press a heat shirkable tube 1130 is defined at one surface of the second half body 1512 facing the first half body 1511 to fix the position of the discharge tip 1100 and prevent the separation of the discharge tip 1100.

In addition, a coupling protrusion 1512a is defined at one side of the second half body 1512 facing the first half body 1511 to couple to the first half body 1511.

As shown, a pair of upper hooks 1521 and 1522 and a pair of lower hooks 1531 and 1532 are disposed on the upper surface and the lower surface of the first half body 1511, respectively, and have the substantially same shape, and a pair of upper hooks 1521 and 1522 and a pair of lower hooks 1531 and 1532 are disposed on the upper surface and the lower surface of the second half body 1512, respectively, and have the substantially same shape.

In this case, the pair of upper hooks 1521 and 1522 and the pair of lower hooks 1531 and 1532 are each spaced apart from the discharge tip 1100 to prevent interference with the discharge tip 1100. Advantageously, the upper hooks 1521 and 1522 may include a rear upper hook 1521 disposed at a rearmost side of the upper surface 1540 of the main body 1510 and a front upper hook 1522 disposed at a foremost side of the main body 1510.

Similarly, the lower hooks 1531 and 1532 may include a rear lower hook 1531 disposed at a rearmost side of a lower surface of the main body 1510 and a front lower hook 1532 disposed at a foremost side of the lower surface of the main body 1510.

In addition, the pair of upper hooks 1521 and 1522 and the pair of lower hooks 1531 and 1532 are deformed in a direction away from each other when the pair of upper hooks 1521 and 1522 and the pair of lower hooks 1531 and 1532 are coupled to the first coupling hole 1412b and the second coupling hole 1422b to minimize the interference with the discharge tip 1100.

In addition, for the same reason, a height (h1) at which the discharge tip 1100 protrudes from the upper surface 1540 may be larger than a height (h2) at which each of the upper hooks 1521 and 1522 protrudes from the upper surface 1540.

The tip holder 1500 may be manufactured by the insert injection in the state in which the discharge tip 1100 and the high voltage cable 1600 are disposed in the mold.

Referring to FIG. 12, a tip holder 1500 and a discharge tip 1100 manufactured by insert injection according to a second embodiment are described.

As shown in FIG. 12, one end of a discharge brush 1110 in the form of a carbon brush is connected to one end of a core wire 1601 of a high voltage cable 1600 through a terminal 1120. One end of the core wire 1601 of the high voltage cable 1600 is exposed to the outside with a cable sheath 1602 peeled off.

When one end of the discharge brush 1110 contacts one end of the core wire 1601 of the high voltage cable 1600, the terminal 1120 covers a contact point in a circumferential direction and presses the contact point thereof.

The discharge brush 1110 of the discharge tip 1100 may be electrically connected to the cable 1600 through the terminal 1120.

A heat shrinkable tube 1130 surrounds at least the contact point between the discharge brush 1110 and the terminal 1120 as shown in FIG. 12. In this case, the heat shrinkable tube 1130 may extend to the contact point between the cable 1600 and the terminal 1120.

As described below, the heat shrinkable tube 1130 preferably extends to a portion of a lower end of the discharge brush 1110 through the contact point between the discharge brush 1110 and the terminal 1120 and covers the contact point between the discharge brush 1110 and the terminal 1120 and the portion of the lower end of the discharge brush 1110 to prevent damage to the discharge brush 1110 by injection pressure.

After the heat shrinkable tube 1130 is disposed, the heat shrinkable tube 1130 is heated to shrink. The contact point between the discharge brush 1110 and the terminal 1120 maintains a first airtight state based on the shrinkage of the heat shrinkable tube 1130.

As shown in FIG. 12, a cable 1600 is bent at a predetermined angle to set an orientation angle of a discharge brush 1110.

FIG. 12 shows a bending portion 1610 bent to make the discharge brush 1110 be almost perpendicular to a horizontal plane, but a bending angle of the bending portion 1610 may be adjusted according to the specifications of products and orientation angles thereof.

In particular, the angle of the bending portion 160 may be adjusted to direct the remaining portion of the discharge tip 1100 among the five discharge tips 1100 except for the discharge brush 1110 disposed at a center of the discharge tip 1100 inward.

After the orientation angle of the discharge brush 1110 of the discharge tip 1100 is set, the discharge brush 1110, the terminal 1120, and the cable 1600 are moved into a cavity of the mold in the state in which the orientation angle of the discharge brush 1110 is set to perform the insert injection.

In this case, the discharge brush 1110 is not advantageously directly exposed to the injection pressure, and the heat shrinkable tube 1130 is not advantageously at least partially disposed at an outside of the cavity to minimize an effect of the injection pressure. That is, after the insert injection is performed, a portion of the heat shrinkable tube 1130 may protrude from an upper surface 1540 of the tip holder 1500 and may be exposed to the outside thereof, and the remaining portion thereof may be disposed inside the tip holder 1500.

As shown in FIG. 12, a contact point between a discharge brush 1110 and a terminal 1120 is disposed at an outside of a cavity of a mold and a contact point between a cable 1600 and the terminal 1120 may be at least partially disposed inside the cavity of the mold.

After the contact portion is disposed in the cavity of the mold, insert injection is performed to form a tip holder 1500.

When the injection is completed, as shown, a contact point between a cable 1600 and a terminal 1120 is at least partially disposed in the tip holder 1500. In this case, the contact point maintains a second airtight state.

Therefore, a processing deviation of an assembly including the discharge brush 1110, the cable 1600, and the tip holder 1500 may be significantly reduced compared to the related art by manufacturing by the insert injection, and moisture penetration into the contact point between the discharge tip 1100 and the cable 1600 may be fundamentally blocked.

In addition, as the contact point between the discharge brush 1110 and the cable 1600 is firmly supported by the tip holder 1500 formed by the insert injection, a possibility of disconnection between the discharge tip 1100 and the cable 1600 may be significantly lowered due to vibration and shock.

<Connection Structure of High Voltage Cable>

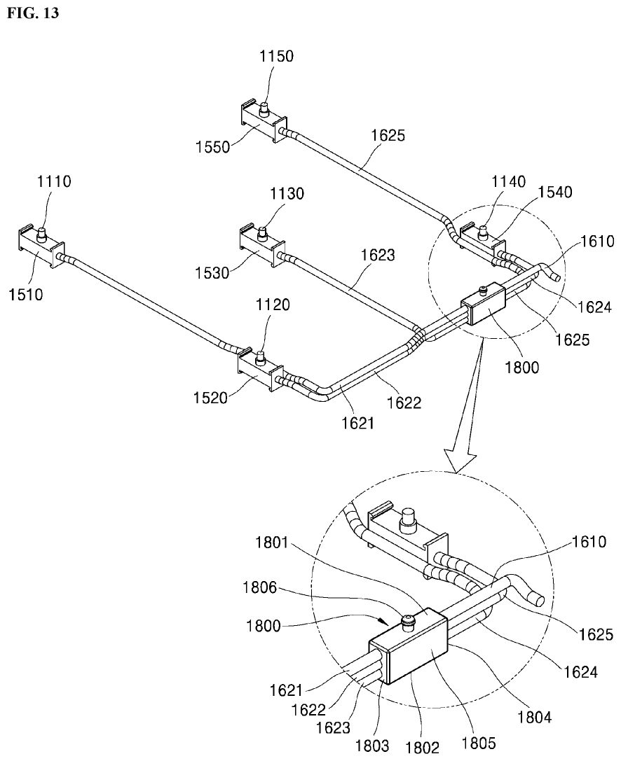

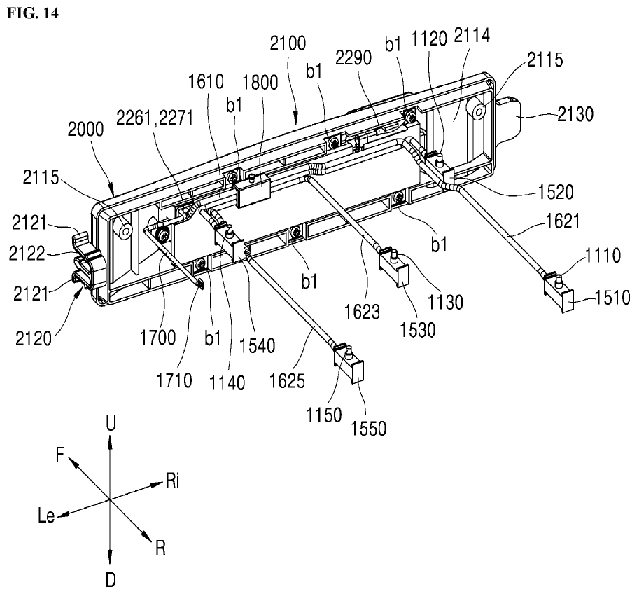

Hereinafter, an arrangement structure of a discharge tip 1100 and a connection structure of a high voltage cable 1600 to supply a voltage to the discharge tip 1100 are described with reference to FIGS. 13 and 14.

Referring to FIG. 13, five discharge tips 1100 and five tip holders 1500 are disposed in an electrification space divided into total nine electrification spaces. The present disclosure is not limited thereto, but is described with respect to an embodiment in which the five discharge tips 1100 and the five tip holders 1500 are provided as shown.

The five discharge tips 1100 are sequentially referred to as a first discharge tip 1110, a second discharge tip 1120, a third discharge tip 1130, a fourth discharge tip 1140, and a fifth discharge tip 1150 as shown to distinguish the five discharge tips 1100. Five tip holders 1500 are sequentially referred to as a first tip holder 1510, a second tip holder 1520, a third tip holder 1530, a fourth tip holder 1540, and a fifth tip holder 1550 as shown to distinguish the five holders 1500.

As shown, the first discharge tip 1110, the second discharge tip 1120, the third discharge tip 1130, the fourth discharge tip 1140, and the fifth discharge tip 1150 are supported on the first tip holder 1510, the second tip holder 1520, the third tip holder 1530, the fourth tip holder 1540, and the fifth tip holder 1550, are spaced apart from one another, and are disposed on the same plane.

In this case, distances between the third discharge tip 1130 disposed at the center thereof and the other discharge tips 1110, 1120, 1140, and 1150 may be set equally. Thereby, ions may be evenly discharged into the air from the discharge tips 1110, 1120, 1130, 1140, and 1150, and electrification efficiency for dust particles may be maximized.

As shown, a first cable 1621, a second cable 1622, a third cable 1623, a fourth cable 1624, and a fifth cable 1625 to supply voltage are connected to the first discharge tip 1110, the second discharge tip 1120, the third discharge tip 1130, the fourth discharge tip 1140, and the fifth discharge tip 1150, and contact points between the discharge tips 1110, 1120, 1130, 1140, and 1150 and the cables 1621, 1622, 1623, 1624, and 1625 are protected in the tip holders 1510, 1520, 1530, 1540, and 1550.

In this case, the first cable 1621, the second cable 1622, the third cable 1623, the fourth cable 1624, and the fifth cable 1625 may be electrically connected to the high voltage supplier 2200. When the first cable 1621, the second cable 1622, the third cable 1623, the fourth cable 1624, and the fifth cable 1625 are electrically connected to the high voltage supplier 2200, a space to support and protect individual cables 1621, 1622, 1623, 1624, and 1625 may be additionally provided, and connection terminals may be individually disposed in the high voltage supplier 2200. In this case, a number of cables or a length of cables is increased and a size of a frame 1400 to support and protect the cables 1621, 1622, 1623, 1624, and 1625 may be increased.

As a means for solving such a problem, an electrification apparatus for electric dust collection 100 according to the present disclosure includes a cable holder 1800 to simplify the connection structure of the high voltage cables 1621, 1622, 1623, 1624, and 1625.

As shown in an enlarged view of FIG. 13, the cable holder 1800 may have a rectangular parallelepiped shape and a lateral width that is larger than each of a vertical height and a thickness in a forward and rearward direction.

A cable connection structure is disposed at an inside of the cable holder 1800 having the rectangular parallelepiped shape to branch a second end of the main cable 1610 having a first end electrically connected to the high voltage supplier 2200 into the first cable 1621, the second cable 1622, the third cable 1623, the fourth cable 1624, and the fifth cable 1625.

That is, the cable holder 1800 protects and maintains the branch portion or a contact point between the main cable 1610 and the plurality of cables 1621, 1622, 1623, 1624, and 1625.

For example, the first end of the main cable 1610 may be electrically connected to the high voltage supplier 2200 and the second end of the main cable 1610 may extend to an inside of the cable holder 1800 through a left surface 1804 of the cable holder 1800. As shown, the second end of the main cable 1610 may extend through an upper portion of the left surface 1804 of the cable holder 1800. That is, only a single main cable 1610 is electrically connected to the high voltage supplier 2200, thereby simplifying a configuration of a connection portion electrically connected to the high voltage supplier 2200.

The second end of the main cable 1610 may extend to an inside of the cable holder 1800 and may be branched into the first cable 1621, the second cable 1622, the third cable 1623, the fourth cable 1624, and the fifth cable 1625.

The first cable 1621, the second cable 1622, and the third cable 1623 protrude outward from the cable holder 180 through a right surface 1803 of the cable holder 1800 and may extend toward the first discharge tip 1110, the second discharge tip 1120, and the third discharge tip 1130, respectively. That is, the first cable 1621, the second cable 1622, and the third able 1623 extend through the right surface 1803 of the cable holder 1800 to supply the voltage to the first discharge tip 1110, the second discharge tip 1120, and the third discharge tip 1130 disposed at a right side of the cable holder 1800 in a lateral direction (i.e., a Le-Ri direction).

The fourth cable 1624 and the fifth cable 1625 may extend through the left surface 1804 of the cable holder 1800 to supply a voltage to the fourth discharge tip 1140 and the fifth discharge tip 1150 disposed at a left side of the cable holder 1800.

In this case, the first cable 1621, the second cable 1622, and the third cable 1623 may protrude from the right surface 1803 of the cable holder 1800 and are disposed in the vertical direction (i.e., a U-D direction) in parallel to one another, and the main cable 1610, the fourth cable 1624, and the fifth cable 1625 may protrude from the left surface 1804 of the cable holder 1800 and may be disposed in the vertical direction (i.e., the U-D direction) in parallel to one another, to minimize a thickness of the cable holder 1800 in a forward and rearward direction thereof.

That is, the same number of cables is disposed at the left surface 1804 and the right surface 1803 of the cable holder 1800, thereby minimizing and optimizing the height of the cable holder 1800 in the forward and rearward direction and minimizing a vertical height of an electrification module 1000.

When the third discharge tip 1130, the fourth discharge tip 1140, and the fifth discharge tip 1150 are disposed at the left side of the cable holder 1800 in the lateral direction (i.e., the Le-Ri direction), the third cable 1623, the fourth cable 1624, and the fifth cable 1625 may be connected to the third discharge tip 1130, the fourth discharge tip 1140, and the fifth discharge tip 1150 through the left surface 1804 of the cable holder 1800, and the main cable 1610, the first cable 1621, and the second cable 1622 may be connected to the first discharge tip 1110 and the second discharge tip 1120 through the right surface 1803 of the cable holder 1800.

The cable holder 1800 may be manufactured by the insert injection in a state in which the main cable 1610 is branched into the first cable 1621, the second cable 1622, the third cable 1623, the fourth cable 1624, and the fifth cable 1625.

The configuration already well-known in the art may be applied to the branch structure of the main cable 1610 into the first cable 1621, the second cable 1622, the third cable 1623, the fourth cable 1624, and the fifth cable 1625 and the insert injection method, and a description of detailed configurations thereof is omitted.

The cable holder 1800 may be accommodated between an upper outer frame 1411 and a lower outer frame 1421 in a state in which an upper surface 1801 of the cable holder 1800 may surface-contact the upper outer frame 1411 and a lower surface 1802 of the cable holder 1800 may surface-contact the lower outer frame 1421. In this case, the cable holder 1800 may be accommodated at a front end 1411d of the upper outer frame 1411 and a front end of the lower outer frame 1421, which are adjacent to a cover module 2000 including a high voltage supplier 2200, to minimize a length of the main cable 1610.

A fixing protrusion 1806 may protrude from the upper surface 1801 of the cable holder 1800 in an upward direction (i.e., a U direction) to fix the cable holder 1800. The front end 1411d of the upper outer frame 1411 may include an insertion hole through which the fixing protrusion 1806 passes.

<Detailed Configurations of Cover Module and High Voltage Supplier>

Hereinafter, detailed configurations of a cover module 2000 and a high voltage supplier 2200 according to an embodiment of the present disclosure are described with reference to FIGS. 14 to 21.

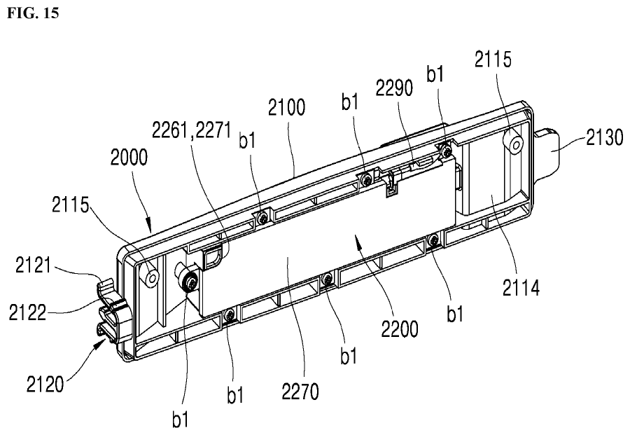

Referring to FIGS. 14 and 15, a voltage is supplied to individual discharge tips 1110, 1120, 1130, 1140, and 1550 and is applied through a single main cable 1610.

A first end of the main cable 1610 is electrically connected to a PCB substrate 2230 to receive the voltage from a high voltage supplier 2200 described below and a second end of the main cable 1610 is branched into a first cable 1621, a second cable 1622, a third cable 1623, a fourth cable 1624, and a fifth cable 1625 and is electrically connected to the individual discharge tips 1110, 1120, 1130, 1140, and 1150.

In this case, a structure of a wire connecting the high voltage supplier 2200 to the individual discharge tips 1110, 1120, 1130, 1140, and 1150 may be simplified and a length and a number of wires may be minimized, thereby significantly reducing manufacturing costs thereof.

As shown, an insulating plate 2260 of the high voltage supplier 2200 may include a cutting portion 2261 and a shielding plate 2270 of the high voltage supplier 2200 may include a cutting portion 2271 to pass the first end of the main cable 1610 toward the PCB substrate 2230.

For example, the cutting portion 2261 may be disposed at a corner of an upper portion of a left side of the insulating plate 2260 and the cutting portion 2271 may be disposed at a corner of the upper portion of a left side of the shielding plate 2270.

A vertical position of each of the cutting portions 2261 and 2271 may be equal to a vertical position of a cable holder 1800 to minimize a length of the main cable 1610.

As shown, a first end of a grounding cable 1700 to ground the conductive plate 1200 may be electrically connected to the PCB substrate 2230 through the cutting portions 2261 and 2271 together with the first end of the main cable 1610. The grounding cable 1700 may include a clip 1701 at a second end thereof to connect to the conductive plate 1200.

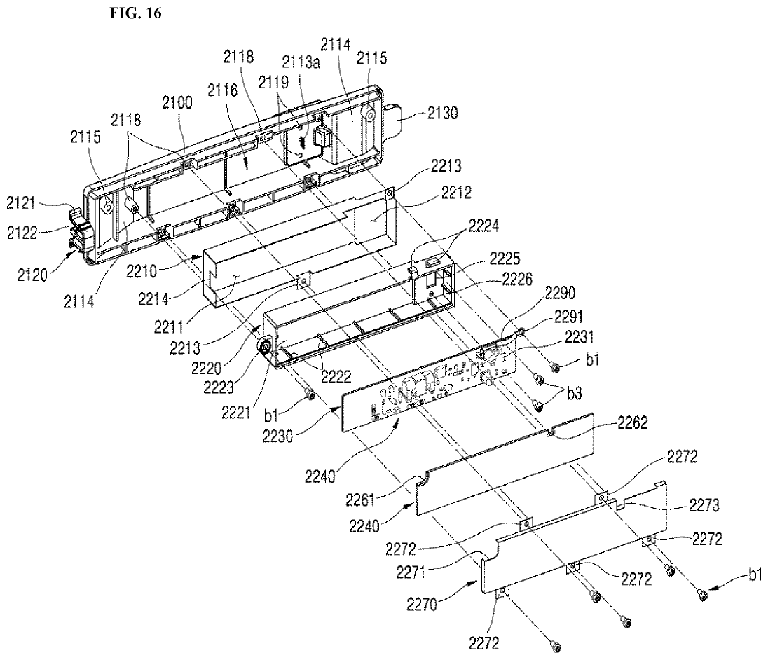

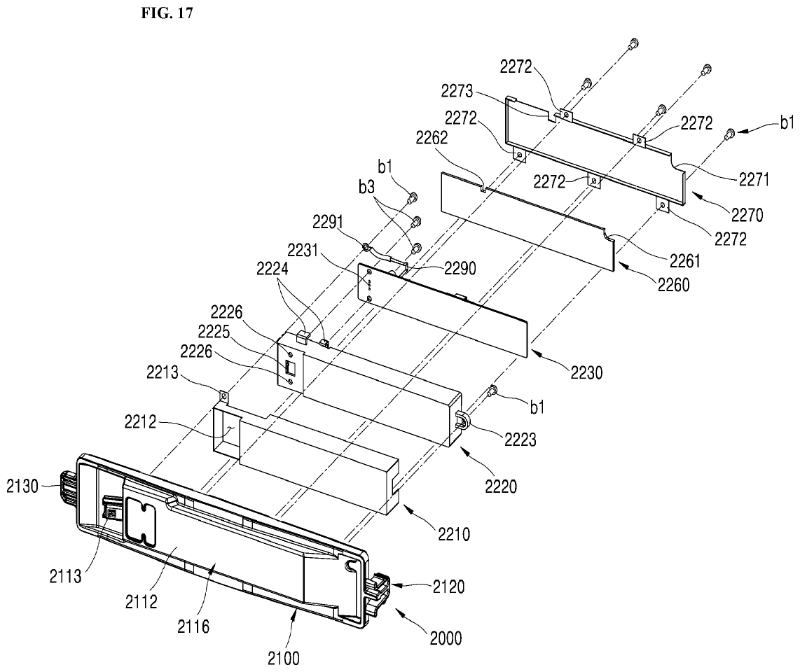

As shown in FIGS. 16 and 17, individual components of the high voltage supplier 2200 are accommodated in a cover 2100 of the cover module 2000.

For example, the high voltage supplier 2200 may be accommodated in an accommodator 2116 disposed at an inside of a cover frame 2110 of the cover 2100.

The accommodator 2116 defines an opening at a rear surface facing a frame 1400 of an electrification module 1000. As described below, the high voltage supplier 2200 may be assembled thereto by being inserted into or disposed in the accommodator 2116 through the open rear surface of the accommodator 2116.

Therefore, an exposed portion of the high voltage supplier 2200 to a front surface 2111 of the cover 2100 may be minimized and damage or the breakage of the high voltage supplier 2200 occurring due to external shock or user carelessness may be minimized.

The cover frame 2110 of the cover 2100 has a protruding surface 2112 that at least partially protrudes when viewed toward a front surface 2111 in order for the accommodator 2116 to obtain an accommodating space 2117 configured to accommodate the high voltage supplier 2200.

That is, the front surface of the accommodator 2116 may include the protruding surface 2212 that protrudes in a direction away from the frame 1400 of the electrification module 1000 and the high voltage supplier 2200 may be disposed between the protruding surface 2112 and the frame 1400. When viewed from the rear, the protruding surface 2112 may be a recess configured to accommodate the high voltage supplier 2200.

That is, when viewed from the rear of the cover 2100, the high voltage supplier 2200 may minimize a protruding portion from a rear surface 2114 of the cover frame 2110 toward the electrification module 1000 and may efficiently accommodate the high voltage supplier 2200 without a reduction in size of the electrification module 1000.

The cover 2100 includes at least one terminal 2113a that extends through the protruding surface 2112 of the accommodator 2116. The terminal 2113a transmits a power to a PCB substrate 2230 described below from an external power supply or transmits a control signal to a PCB substrate 2230 described below from a controller of a vehicle.

For this transmission, a first end of the at least one terminal 2113a protrudes outward through the front surface of the accommodator 2116 and a second end of the at least one terminal 2113a protrudes to the accommodating space 2117 through the rear surface of the accommodator 2116.

As described below, the first end of the at least one terminal 2113a extends to an inner side of a main connector 2113 disposed on a front surface of the accommodator 2116 and the second end of the at least one terminal 2113a is electrically connected to the PCB substrate 2230.

FIG. 16 shows three terminals 2113a having a same shape and that are spaced apart from one another by a predetermined distance. The present disclosure is not limited thereto, but is described with respect to an embodiment in which the three terminals 2113a are disposed in a cover 2100.

The cover 2100 may be manufactured by plastic injection molding. When the cover 2100 is injection-molded, the three terminals 2113a may be disposed in the cover 2100 by insert injection in a state the three terminals 2113a are already disposed in a mold.

A main connector 2113, preferably a female connector, is disposed at one side of the protruding surface 2112, for example, a side surface of the protruding surface 2112 to supply external power or receive a control signal. In this case, the main connector 2113 may be integrated with the cover 2100 during the injection molding of the cover 2100 to protrude the first end of the three terminals 2113a inward the main connector 2113.

As shown, the main connector 2113 may protrude sideward to prevent an excessive increase in size of the cover module 2000 in a forward and rearward direction.

A retainer 2120 and an engaging protrusion 2130 are disposed at both ends of the cover frame 2110. A cover module 2000 may be detachably coupled to an installation portion, for example, a dust collecting installation portion 13 of an air conditioner for vehicle 1 using the retainer 2120 and the engaging protrusion 2130.

For example, the retainer 2120 may include a grip 2121 to which a force is applied to a free end by a user and a stopper 2122 disposed between a fixed end and the free end thereof. Any means already well-known in the art may be applied to the components of the retainer 2120 and a detailed description thereof is omitted hereinafter.

A pair of main bosses 2115 may be defined on a rear surface 2114 of the cover frame 2110 adjacent to both ends of the cover frame 2110 by avoiding the accommodator 2116 to couple to a frame 1400 of the electrification module 1000, for example, an upper frame 1410 of the electrification module 1000. That is, the pair of main bosses 2115 may be defined at both sides of the accommodator 2116.

In addition, a plurality of sub-bosses 2118 may be defined on the rear surface 2114 of the cover frame 2110 to couple to the high voltage supplier 2200. As shown, the high voltage supplier 2200 may be coupled to the accommodator 2116 of the cover frame using a total of seven first bolts (B1), and correspondingly, a total of seven sub-bosses 2118 may be defined at a circumference of the high voltage supplier 2200.

The high voltage supplier 2200 includes a conductive first case 2210, an insulating second case 2220 accommodated in the first case 2210, a PCB substrate 223 configured to place a circuit component 2240 and accommodate the second case 2220, an insulating plate 2260 configured to cover the PCB substrate 2230, and a shielding plate 2270 disposed at a rear side of the insulating plate 2260 and configured to block an electromagnetic wave generated by the PCB substrate 2230.

The first case 2210 is inserted into the accommodator 2116 of the cover 2100 and directly contacts and is supported by an inner surface of the accommodator 2116, and defines an outer appearance of the high voltage supplier 2200.

The first case 2210 may be formed by processing a metal plate into a box shape defining an opening at a rear surface thereof to block external release of an electromagnetic wave generated by the PCB substrate 2230. A second case 2220 and a PCB substrate 2230 described below are each accommodated in an inner space 2211 of the first case 2210.

The first case 2210 facing the accommodator 2116 may define an opening at a portion of the front surface thereof facing the accommodator 2116, include a first through-hole 2212 at the opening thereof, and the second end of the terminal 2113a and a third bolt (b3) to couple to the PCB substrate 2230 may pass through the first through-hole 2212.

In addition, bolt fasteners 2213 including through-holes may be bent and may be disposed on a lower surface and an upper surface of the first case 2210. A first bolt (b1) may be coupled to the sub-boss 2118 of the cover 2100 through the through-hole.

In this case, when the first bolt (b1) couples the bolt fastener 2213 disposed on the upper surface thereof to the cover 2100, the first bolt (b1) may also couple a ring-shaped terminal 2291 disposed at a second end of the case grounding cable 2290 for grounding of the first case 2210. As shown, a first end of the case grounding cable 2290 is electrically connected to the PCB substrate 2230.

The first case 2210 may include a notch-shaped cutting portion 2214 on a left surface thereof to insert the bolt fastener 2223 of the second cable 2220 described below. The cutting portion 2214 may have a vertical width corresponding to that of the bolt fastener 2223 of the second case 2220.

The second case 2220 is inserted through the open rear surface of the first case 2210 and is disposed in the inner space 2211 of the first case 2210.

The second case 2220 may be formed by processing insulating plastic material into a box shape defining an opening at one surface thereof to insulate the PCB substrate 2230 disposed in the inner space 2221 of the second case 2220 from the first case 2210.

The second case 2220 may include a plurality of guide ribs 2222 on the inner surface thereof to support the PCB substrate 2230. The plurality of guide ribs 2222 may each protrude from an inner surface toward the inner space 2221 to have a predetermined height and may linearly extend toward the rear surface from the front surface thereof in a direction parallel to an insertion direction of the PCB substrate 2230.

The second case 2220 may include the bolt fastener 2223 on an outer surface of a left side of the second case 2220. The bolt fastener 2223 is inserted into the cutting portion 2214 of the first case 2210 when the second case 2220 is inserted into the inner space 2211 of the first case 2210.

The second case 2220 may include at least one cable rib 2224 on an upper surface thereof to support a case grounding cable 2290.

The cable rib 2224 may have a hook shape that protrudes from the upper surface of the second case 2220 to support the first end and the second end of the case grounding cable 2290.

Referring to FIGS. 16 and 17, two cable ribs 2224 are integrated with the upper surface of the second case 2220. However, the present disclosure is not limited thereto and a number and a position of the cable ribs 2224 may be adjusted based on a length and an extending direction of the case grounding cable 2290.

The second case 2220 facing the accommodator 2116 may define an opening on a front surface thereof, a second through-hole 2225 may be defined at the opening thereof, and the second end of the terminal 2113a may pass through the second through-hole 2225. In addition, a bolt hole 2226 may be defined at a periphery of the second through-hole 2225 and a third bolt (b3) may pass through the bolt hole 2225 to couple the PCB substrate 2230.

The PCB substrate 2230 may place a plurality of circuit components 2240 and may use any substrate known in the art. A lateral length of the PCB substrate 2230 may be larger than a vertical width thereof to minimize a thickness of the high voltage supplier 2200 in the forward and rearward direction.

The PCB substrate 2230 may be accommodated in the inner space 2221 through the open rear surface of the second case 2220 and may be electrically connected to the terminal 2113a in the accommodating process. The PCB substrate 2230 may include a pin hole 2231 having a number corresponding to that of the terminals 2113a and a bolt hole may be defined at the periphery of the pin hole 2231 and the third bolt (b3) may pass through the bolt hole.

In addition, the first end of the main cable 1610 and the first end of the grounding cable 1700 may be electrically connected to the PCB substrate 2230 and the first end of the case grounding cable 2290 may be electrically connected to the PCB substrate 2230.

After the PCB substrate 2230 is disposed at and coupled to an inside of the second case 2220, an insulating resin 2250 such as epoxy resin may be injected to the periphery of the PCB substrate 2230 to prevent damage to the circuit component 2240 occurring due to moisture and penetration of foreign objects.

The insulating plate 2260 covers the open rear surface of the second case 2220 and insulates the rear surface thereof after the PCB substrate 2230 is accommodated in the case 2220.

Similar to the second case 2220, the insulating plate 2260 may be formed by processing insulating plastic material into a plate shape.

The insulating plate 2260 may have a shape corresponding to that of the open rear surface of the second case 2220. In this case, the insulating plate 2260 may include the first cutting portion 2261 at a corner of an upper end of a left side of the insulating plate 2260 and a cable notch 2262 at an edge of an upper portion thereof to pass the case grounding cable.

The shielding plate 2270 is disposed at the rear side of the insulating plate 2260 and blocks the electromagnetic wave emitted from the PCB substrate 2230 toward the rear.

The shielding plate 2270 may be formed by processing the metal plate to have the substantially same shape as the insulating plate 2260 and entirely covers the rear surface of the insulating plate 2260.

The shielding plate 2270 may have a shape corresponding to that of the open rear surface of the second case 2220. In this case, similar to the insulating plate 2260, the second cutting portion 2271 may be disposed at a corner of an upper portion of a left side of the shielding plate 2270 and the cable notch 2273 may be defined at an edge of an upper side thereof to pass the case grounding cable 2290.

A plurality of bolt fasteners 2272 may be integrated with an upper edge and a lower edge of the shielding plate 2270.

Referring to FIGS. 16 and 17, for example, five bolt fasteners 2272 are integrated with the upper edge and the lower edge of the shielding plate 2270; however, the present disclosure is limited thereto, and a number and a position of the bolt fasteners 2272 may be adjusted according to the size of the high voltage supplier 2200.

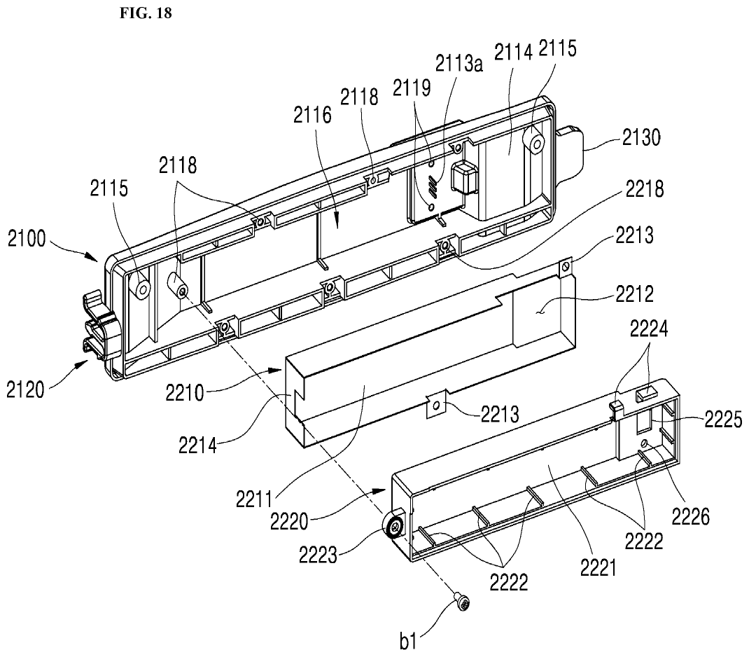

Hereinafter, an assembly process of the high voltage supplier 2200 is described with reference to FIGS. 18 to 21.

As shown in FIG. 18, a first case 2210 is inserted into an accommodator 2116 defined at a rear surface 2114 of the cover frame 2110.

After the first case 2210 is inserted, a second case 2220 is inserted into the first case 2210 through the opening defined at the rear surface of the first case 2210.

In this case, the bolt fastener 2223 of the second case 2220 may be coupled to a sub-boss 2118 defined at the rear surface 2114 of the cover 2100 using a first bolt (b1) to couple a side surface thereof.

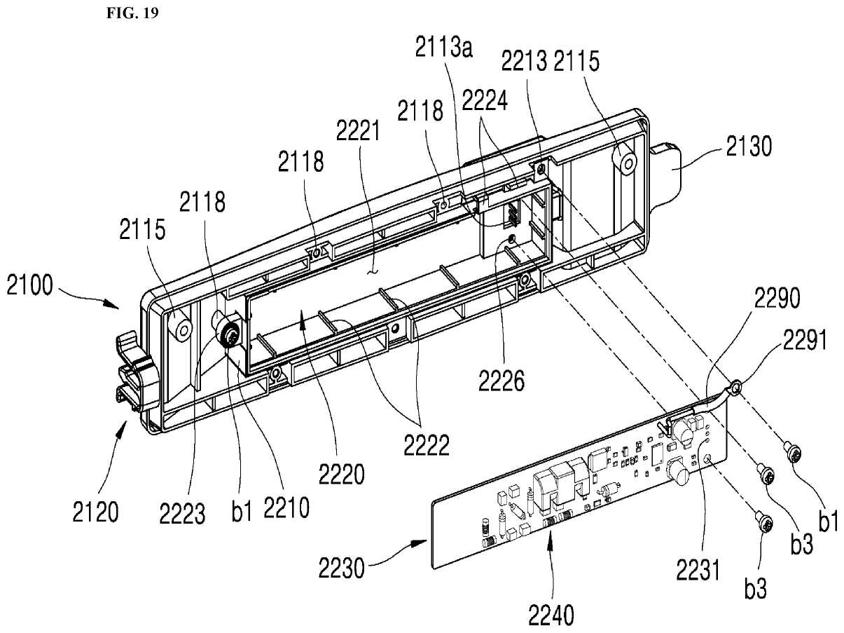

After the second case 2220 is coupled, a PCB substrate 2230 is inserted through the opening defined at the rear surface of the second case 2220 as shown in FIG. 19.

In this case, the PCB substrate 2230 is electrically connected to a first end of the terminal 2113a as the first end of the terminal 2113a is inserted into the pin hole 2231 of the PCB substrate 2230. After the terminal 2113a is connected, the PCB substrate 2230 is coupled at two positions using third bolts (b3).

After the PCB substrate 2230 is coupled, a ring-shaped terminal 2291 disposed at one end of the case grounding cable 2290 is coupled to the bolt fastener 2213 disposed on the upper surface of the first case 2210 using a first bolt (b1). In this case, the first case 2210 is electrically connected to the case grounding cable 2290. The second end of the case grounding cable 2290 is already connected and coupled to the PCB substrate 2230 before the ring-shaped terminal 2291 is coupled.

Referring to FIG. 19, the PCB substrate 2230 is coupled to the second case 2220 in a state in which the circuit component 2240 is placed on the PCB substrate 2230. Alternatively, the assembly may be performed by coupling the PCB substrate 2230 to the second case 2220 and subsequently placing the plurality of circuit components 2240 on the PCB substrate 2230. The present disclosure is not limited thereto, but is described with respect to an embodiment in which the plurality of circuit components 2240 are already placed on and then assembled to the PCB substrate 2230.

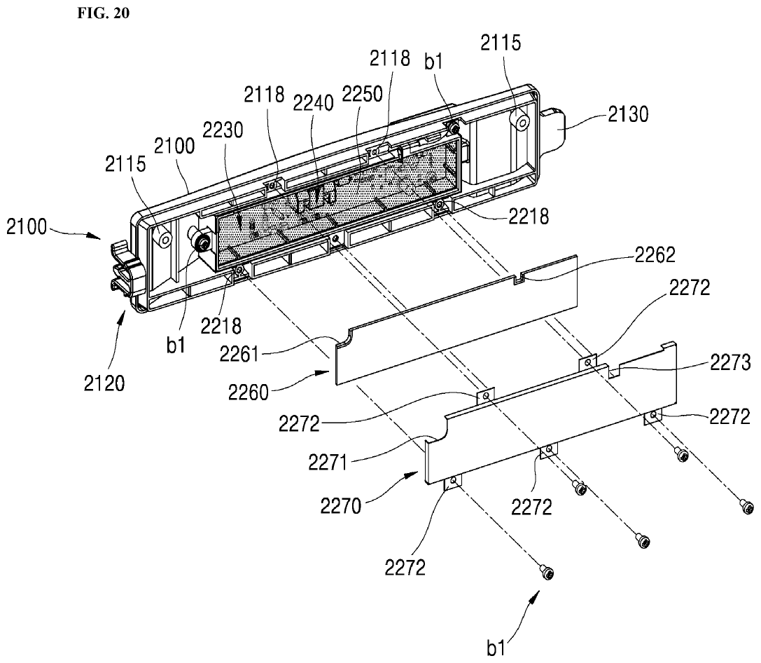

After the PCB substrate 2230 is coupled, as shown in FIG. 20, an insulating resin 2250 such as epoxy resin is injected and cured to a periphery of a PCB substrate 2230 and a plurality of circuit components 2240.

In this case, the insulating resin 2250 may be preferably injected to entirely dip the plurality of circuit components 2240.

That is, the damage to the circuit component 2240 due to the moisture and penetration of other foreign objects may be effectively prevented based on the injection of the insulating resin 2250.

The insulating plate 2260 is inserted into the opening defined at the rear surface of the second case 2220 after or before the insulating resin 2250 is cured.

After the position of the insulating plate 2260 is set and the insulating plate 2260 is disposed, the shielding plate 2270 is disposed at the rear side of the insulating plate 2260 and is coupled to a rear surface of the cover 2100 using five first bolts (b1).

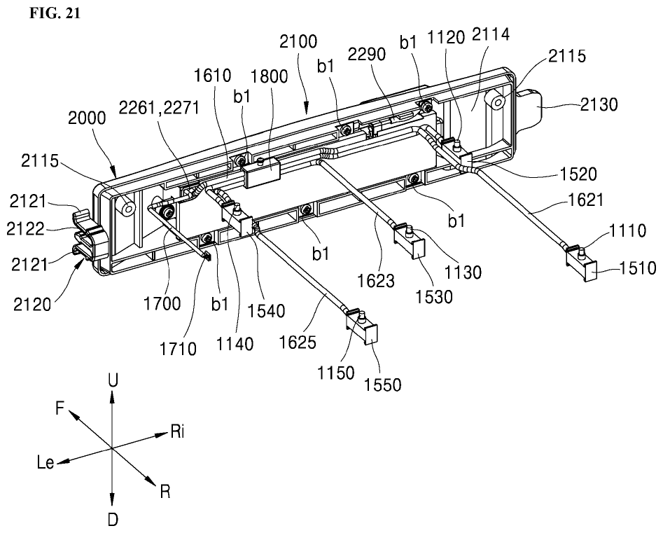

After the shielding plate 2270 is coupled, the assembly of the high voltage supplier 2200 is completed as shown in FIG. 21.

Subsequently, the first end of the main cable 1610 and the first end of the grounding cable 1700 of the electrification module 1000 pass through the first cutting portion 2261 of the insulating plate 2260 and the second cutting portion 2271 of the shielding plate 2270 and are electrically connected to the PCB substrate 2230. A connector may be disposed at the first end of the main cable 1610 and the first end of the grounding cable 1700 for electrical connection to the PCB substrate 2230.

Subsequently, the assembly of the electrification apparatus for electric dust collection 1000 may be completed by coupling a main boss 2115 defined on the rear surface of the cover 2100 to the connector 1411b disposed at the upper frame 1410 of the electrification module using a second bolt (b2).

The embodiment shows that the cover module 2000 and the frame 1400 of the electrification module 1000 are connected to be immovable relative to each other. Alternatively, a hinge structure may be used for at least one of the frame 1400 of the electrification module or the cover module 2000. In this case, an angle between the frame 1400 of the electrification module or the cover module 2000 may be adjusted.

By pivotally folding the cover module 2000, the assembly of the electrification module 1000 and the cover module 2000 may be easily taken out from or inserted into a vehicle that does not allow easy taken-out from or insertion into the installation portion.

The present disclosure has been described with reference to drawings hereinabove; however, the present disclosure is not limited to the embodiments and the exemplary drawings herein, and various modifications can be made by the skilled person in the art within the scope of the technical idea of the present disclosure. Further, even if working effects obtained based on the configurations of the present disclosure are not explicitly described in the description of embodiments of the present disclosure, effects predictable based on the corresponding configuration have to be recognized.

### DESCRIPTION OF REFERENCE NUMERALS

| | |
|---|---|
| 100: Electrification apparatus for | |
| electric dust collection | |
| 1000: Electrification module | |
| 1100: Discharge tip | 1200: Conductive plate |
| 1400: Frame | 1500: Tip holder |
| 1600: High voltage cable | 1800: Cable holder |
| 2000: Cover module | 2100: Cover |
| 2200: High voltage supplier | |

What is claimed is:

1. An electrification apparatus for dust collection, comprising:
an electrification module configured to generate an ion that is emitted to air,
wherein the electrification module comprises:
at least one discharge tip configured to emit the ion in a direction opposite to a flow direction of the air;
a conductive plate configured to generate a potential difference with the discharge tip;
a frame that defines an appearance of the electrification module and that supports the discharge tip and the conductive plate; and
a high voltage supplier configured to generate a voltage to supply the voltage to the discharge tip.

2. The electrification apparatus of claim 1, further comprising a cover module that is disposed at a front side of the electrification module and that is coupled to the frame,
wherein the high voltage supplier is accommodated in the cover module.

3. The electrification apparatus of claim 2, wherein the cover module comprises an accommodator that defines an accommodating space configured to accommodate the high voltage supplier and that defines an opening at a rear side facing the frame.

4. The electrification apparatus of claim 3,
wherein a front surface of the accommodator protrudes in a direction away from the frame, and
wherein the high voltage supplier is disposed between the front surface of the accommodator and the frame.

5. The electrification apparatus of claim 3, wherein the cover module comprises at least one terminal having a first end that protrudes from a front surface of the accommodator and a second end that protrudes to the accommodating space through the opening at the rear side of the accommodator.

6. The electrification apparatus of claim 5, wherein the cover module further comprises a connector disposed at the front surface of the accommodator, and
wherein the first end of the at least one terminal extends to an inside of the connector.

7. The electrification apparatus of claim 6, wherein the at least one terminal is coupled to the cover module by insert injection molding.

8. The electrification apparatus of claim 6, wherein the connector is integrated with the cover module.

9. The electrification apparatus for electric dust collection of claim 5, wherein the high voltage supplier comprises:
a conductive first case that is disposed at the accommodator and that defines an opening at a rear side;
an insulating second case that is inserted into the conductive first case through the opening at the rear side of the conductive first case and that defines an opening at a rear side; and
a printed circuit board (PCB) substrate that is configured to accommodate a plurality of circuit components and that is inserted into the opening at the rear side of the insulating second case,
wherein the PCB substrate is electrically connected to a second end of the at least one terminal.

10. The electrification apparatus of claim 9,
wherein the conductive first case defines a first through-hole through which the second end of the at least one terminal passes, and
wherein the insulating second case defines a second through-hole through which the second end of the at least one terminal passes.

11. The electrification apparatus of claim 9, wherein the high voltage supplier further comprises a case grounding cable having a first end electrically connected to the PCB substrate and a second end electrically connected to the conductive first case.

12. The electrification apparatus of claim 11, wherein the insulating second case comprises a cable rib configured to fix the case grounding cable.

13. The electrification apparatus of claim 12, wherein the high voltage supplier further comprises:
an insulating plate disposed at a rear surface of the insulating second case facing the rear side; and
a shielding plate disposed at a rear side of the insulating plate.

14. The electrification apparatus of claim 13, wherein the electrification module further comprises a high voltage cable configured to electrically connect the discharge tip to the PCB substrate.

15. The electrification apparatus of claim 14, wherein the high voltage cable comprises a main cable having a first end electrically connected to the PCB substrate.

16. The electrification apparatus of claim 15,
wherein the insulating plate defines a first cutting portion through which the main cable passes, and
wherein the shielding plate defines a second cutting portion through which the main cable passes and corresponding to the first cutting portion of the insulating plate.

17. The electrification apparatus of claim 16,
wherein the electrification module further comprises a grounding cable having a first end electrically connected to the PCB substrate and a second end electrically connected to the conductive plate, and
wherein the first end of the grounding cable is connected to the PCB substrate through the first cutting portion and the second cutting portion.

18. The electrification apparatus of claim 16,
wherein the first cutting portion is defined at a corner of an upper end of the insulating plate.

19. The electrification apparatus of claim 15,
wherein the insulating plate defines a first cable notch through which the case grounding cable passes, and
wherein the shielding plate defines a second cable notch through which the case grounding cable passes and corresponding to the first cable notch of the insulating plate.

20. The electrification apparatus of claim 19,
wherein the first cable notch is defined at an edge of an upper portion of the insulating plate.
